(19) United States
(12) Patent Application Publication
(10) Pub. No.: US 2005/0029242 A1
(43) Pub. Date: Feb. 10, 2005

(54) Brazed copper heat exchangers and method for making same by welding

(76) Inventors: Christian Bonnet, Puiseux (FR); Marc Wagner, Saint Maur des Fosses (FR); Jean-Marie Fortain, Osny (FR)

Correspondence Address: Air Liquide;Intellectual Property Department, 2700 Post Oak Blvd, Suite 1800, Houston, TX, 77056, US

(21) Appl. No.: 10/496,721

(22) PCT Filed: Oct. 14, 2002
(86) PCT No.: PCT/FR02/03509

(30) Foreign Application Priority Data
Nov. 22, 2001 (FR) 01/15118

(51) Int. Cl. B23K 9/00

(52) U.S. Cl. 219/137 WM; 219/146.22

(57) ABSTRACT

The invention concerns a method for arc-welding of at least a metal workpiece (1) on a matrix (2) comprising at least a brazed zone (3) whereof the brazing contains copper and phosphorus, which comprises the following steps: (a) producing on at least part of the brazed zone (3), a deposition of at least a layer (5, 6, 7) of pure copper or of a copper alloy for which the phosphorus solubility limit is between about 0.1 and 3.5% at solidification temperature; and (b) welding the metal workpiece (1) on said at least one copper layer (5, 6, 7) deposited in step (a). The invention also concerns a method for making a brazed heat exchanger using such a welding process. The invention further concerns the resulting heat exchangers and their use in cryogenic gas separation, in particular air separation in a cryogenic separating unit.

The invention relates to a process for welding brazed copper heat exchangers, to a process for manufacturing heat exchangers by welding, to the exchangers obtained by such a process and to their use for the separation of gases, especially air.

Copper heat exchangers are usually manufactured firstly by stacking plates and fins, that are brazed together to form a matrix, and then by adding one or more fluid collecting containers serving for collecting and distributing the fluids treated in the equipment.

The fluid collecting container(s), also called headers, are attached and fastened in a known manner to the brazed matrix of the exchanger by welding.

In the general case of copper/copper bonding by welding, it is common practice to use a copper alloy (copper/nickel alloy or copper/aluminum alloy, etc.) as filler product as it is easier to use than pure copper.

However, in the particular case of joining one or more headers to a brazed matrix during the manufacture of a heat exchanger, the weld joining the fluid header to the matrix necessarily crosses the braze-filled interstices that connect the constituent plates and fins of this part of the exchange together.

Currently, two types of brazing alloy are used to braze copper, namely copper/silver alloys, which are very expensive, and copper/phosphorus alloys, which are very much less expensive but generally contain an amount of phosphorus between about 5% and about 8% by weight. Adding silver or phosphorus in fact significantly lowers the melting point of the alloy with respect to pure copper, typically by several hundred degrees Celsius, this being essential in order to be able to carry out a brazing operation.

However, several problems arise when the matrix formed from brazed plates and fins has been manufactured using a braze with a copper alloy to which phosphorus has been added.

This is because, when welding the brazed copper matrix, for example to a copper collecting vessel, the region of brazing of the matrix located in the joint plane that has to be welded will be mixed with the welding alloy used for producing the welded joint between this brazed matrix and the wall of the container that has to be welded thereto.

This may then result in vaporization of the phosphorus, deriving a risk of porosity as the temperature of the weld pool is much higher than the brazing temperature, and above all embrittlement of the welded joint thus produced using conventional filler products, since the solubility of phosphorus in the alloys normally used for welding is very low. This results, during solidification of the joint, in substantial phosphorus segregation and, as a consequence, the formation of brittle zones very rich in phosphorus.

This may then lead to welded joint cracking phenomena and leaks or other sealing problems may then occur on the exchanger thus manufactured.

The object of the invention is therefore to propose an improved welding process applicable to the manufacture of brazed copper heat exchangers that makes it possible to alleviate the abovementioned problems, and also improved exchangers obtained by this process that do not have leakage problems or problems of poor sealing.

In other words, the problem posed is to be able to weld copper parts of heat exchangers effectively, without forming phosphorus-rich brittle zones, and therefore to provide a process for welding heat exchangers that results in the production of exchangers of greater strength than exchangers whose constituent underlying parts were welded by using conventional processes.

The invention therefore relates to a process for the arc welding of at least one metal workpiece to a matrix comprising at least one brazed zone, the braze of which contains copper and phosphorus, in which a procedure is carried out in accordance with the following successive steps:
(a) at least one layer of pure copper or of a copper alloy for which the phosphorus solubility limit is between 0.1 and 3.5% at the solidification temperature is deposited on at least part of the brazed zone; and
(b) the metal workpiece is welded to said at least one layer of copper deposited in step (a).

Within the context of the invention, the percentages (%) are percentages by weight.

Depending on the case, the process of the invention may include one or more of the following technical features:
in step (a), the copper alloy has a phosphorus solubility limit of between approximately 0.5 and 3.5% at the solidification temperature, preferably between approximately 1 and 3.5%;
in step (a), several layers based on copper are deposited, these being at least partly superposed one with respect to another;
the brazed matrix furthermore contains at least one braze element chosen from Sn, Ag and Zn;
the copper or the copper alloy constituting the layer or layers deposited in step (a) furthermore contain at least one additional element chosen from tin, silicon, manganese, iron and nickel;
the braze contains 3 to 10% phosphorus, 0 to 15% silver and 0 to 1% nickel and/or the layer or layers deposited in step (a) contain less than 1% tin, less than 0.5% manganese, less than 0.5% silicon and less than 0.05% iron;
the deposition of at least one layer of copper of step (a) is carried out by:
(i) locally preheating the zone to be coated with copper, and
(ii) supplying copper and depositing, in the zone preheated in step (i), copper melted by an electric arc;
the preheating of the zone to be coated with copper of step (i) is carried out by using one or more electric arcs, preferably at least one arc generated by a TIG or plasma welding torch;
in step (ii) the copper is supplied in the form of a copper wire and the electric arc for melting said copper wire is generated by at least one MIG welding torch;
in step (b), the workpiece (1) is welded by an MIG, TIG or plasma process, or a combination of these processes, preferably a pulsed MIG process;
the brazed matrix is supported by a stack of several plates separated by fins forming spacers between said plates, said fins and said plates being brazed to one another so as to form said brazed matrix;
the workpiece is a component of a fluid collecting and/or distributing container forming part of a heat exchanger, said workpiece preferably being made of copper or stainless steel.
the layer deposited on the matrix has a width sufficient to allow a welded joint to be produced between the workpiece and said layer without incorporating into said joint additional elements coming from the brazed zone of the matrix.

The invention also relates to a process for manufacturing a brazed copper heat exchanger, in which the welding process of the invention is used to weld at least one fluid collecting and distributing container, preferably made of copper, of the exchanger to a stack of plates separated by fins forming spacers between said plates and supporting at least one brazed matrix.

The invention also relates to a copper heat exchanger comprising at least one fluid collecting and distributing container welded to a brazed matrix supported by a stack of several plates separated by fins forming spacers between said plates, characterized in that said container is welded to at least one layer of pure copper or a copper alloy for which the phosphorus solubility limit is between approximately 0.1 and 3.5% at the solidification temparture, said at least one copper layer being deposited on said brazed matrix. The welded fluid collecting and distributing container is preferably made of copper or stainless steel.

According to another aspect, the invention also relates to a plant for separating fluids, particularly gas mixtures, comprising at least one exchanger of the invention, preferably said plant being a cryogenic air separation unit.

According to yet another aspect, the invention relates to a process for separating fluids, particularly gas mixtures, in which at least one heat exchanger of the invention is used, the fluid preferably being air.

More generally, the invention also relates to a process for coating a matrix comprising at least one brazed zone, the braze of which contains copper and phosphorus, in which a procedure is carried out in accordance with the following steps:
(1) the zone to be coated is preheated by exposing said zone to at least a first electric arc;
(2) copper in the form of a meltable wire is supplied and said copper wire is progressively melted by means of at least a second electric arc with deposition on the zone preheated by the first electric arc of step (1) of copper melted by the second electric arc, said copper wire consisting of pure copper or a copper alloy for which the phosphorus solubility limit is between approximately 0.1 and 3.5% at the solidification temperature; and
(3) the molten copper is made to solidify as at least one copper layer.

The invention is illustrated in the figures appended hereto.

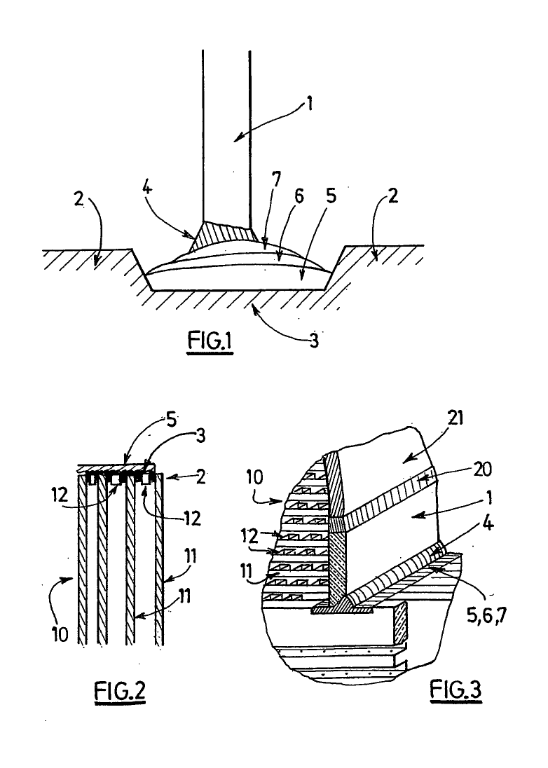

FIG. 1 shows the principle of the invention applicable to the welding of a workpiece 1, for example a fluid collecting and distributing container for a heat exchanger, to a brazed 3 matrix 2, such as the brazed matrix 2 of a heat exchanger formed by brazing a stack of plates 11 separated by fins 12 forming spacers, as shown in detail in FIG. 2.

To avoid the abovementioned problems of the weld 4 cracking, the workpiece 1 is not welded directly to the matrix 2 having the brazed zone 3 formed from a copper alloy generally containing less than 10% phosphorus and optionally other compounds, as is commonly done in the prior art.

This is because, by operating as in the prior art, it has been found that during welding of the header to the brazed matrix of an exchanger, a small thickness of the brazed exchanger (matrix) is melted by the molten welding material, and the braze is then mixed with the metal deposit (welded joint), but not uniformly throughout the deposit.

In the molten metal near the braze, local enrichment with the elements contained in the braze then occurs. Among these elements, the inventors of the present invention have demonstrated that phosphorus is the one that is the origin of the cracking problems arising in the prior art if the local phosphorus concentration exceeds the solubility limit in the “local alloy” resulting from the non-uniform mixing of the deposited metal, the copper of the exchanger and the braze.

According to the invention, to avoid this phosphorus-induced cracking problem, one or more superposed layers 5, 6, 7 of pure copper or of a copper alloy are firstly deposited on that face of the matrix 2 having the braze 3, so as to constitute a base to which the workpiece 1 is then welded; these superposed copper layers 5, 6, 7 covering the brazed surface 3 are called “buttering” layers.

In this way, the “buttering” layers 5, 6, 7, of copper deposited on the surface on which the brazed interstices 3 of the matrix 2 terminate, constitute an isolating barrier that prevents any possible contamination of the welded joint 4 by resurgence of deleterious elements coming from the braze 3 during subsequent welding of the workpiece 1 to the buttering layers 5 to 7.

In fact, the copper layers 5 to 7 thus formed may accept a considerable amount of contaminants, as dilution, up to approximately 3.5% by weight in the case of phosphorus, for example, without substantially deteriorating thereby. The maximum value of 3.5% corresponds to the solubility limit of phosphorus in pure copper at the solidification temperature of the alloy thus obtained, the solubility limit of an element (phosphorus) in another element (copper) being defined in metallurgy as being the maximum content of the first element that can be alloyed with the second without the appearance of a second phase; see Dr. M. Hansen, Constitution of binary alloys, McGraw-Hill Book Company, Inc.

According to the invention, the workpiece 1 is therefore welded, along the welded joint 4, to the buttering layer or layers 5 to 7 of copper deposited beforehand on the brazed matrix 3, and not directly to the brazed zone 3, as is conventionally done in the prior art.

However, a difficulty arises when welding copper with a copper filler product because the copper melts and solidifies at a fixed temperature and not within a temperature range like most alloys. Consequently, the weld pool is very difficult to handle for a welder and the beads obtained are generally poorly “wetted”, that is to say the sides of the bead are poorly connected to the base metal, and they often also exhibit bonding-type defects, that is to say the filler metal is “laid down” on the base metal without the latter melting.

Attempts may be made to overcome these problems by preheating the exchanger, but this operation is very difficult to control because, owing to the very high thermal conductivity of copper, the heat supplied in the welding zone very rapidly diffuses into the entire exchanger, which means that the entire heat exchanger has to be heated to the preheat temperature, for example to 300° C. It may therefore be appreciated that to proceed in this way is lengthy and expensive, and may result in defects in the buttering, as this causes oxidation of the surface on which it is desired to deposit the weld beads.

To avoid all these drawbacks, trials of implementing the invention have shown that it is possible to dispense with preheating the zone to be welded if the MIG torch is preceded, a few centimeters ahead, by an electric arc, for example an deconfined plasma or TIG arc, or several arcs, placed transversely or longitudinally with respect to the welding direction. This provides very local but effective preheating, since the heat thus provided by the preheating arc(s) does not have time to diffuse significantly into the mass of the exchanger, because of the short time that elapses between the preheating pass with the plasma or TIG arc(s) and the pass by the MIG torch that deposits the filler metal.

Another satisfactory solution consists in using a hybrid plasma/MIG torch characterized by a plasma arc that surrounds the filler wire and the MIG arc.

When it is desired to minimize contamination, several welding passes are advantageous as they allow several superposed “buttering” layers 5 to 7 of pure copper to be obtained.

Of course, the buttering layers 5 to 7 have a sufficient width and will be made with pure copper or, where appropriate, a copper alloy for which the phosphorus solubility limit is again high enough at the solidification temperature, for example of 0.5 to 1%, so that phosphorus coming from the braze and introduced into the buttering layer 5 is able to be diluted sufficiently to avoid the formation of cracks and an additional weld 4 can be produced without risking the integrity of the structure.

This process is particularly well suited to the manufacture of brazed heat exchangers that can be used for separating gases, in particular cryogenically within cryogenic distillation columns.

The detailed structure of a heat exchanger will not be described hereinbelow as it is well known in the industry and can also be seen in particular on the Internet site www.alpema.org or described in “The Standards of the Brazed Aluminum Plate-Fin Heat Exchanger Manufacturers Association”, ALPEMA, Second Edition, 2000.

The detailed structure of the brazed zone of a copper exchanger 10 of this type, seen in cross section, is indicated schematically in FIGS. 2 and 3 which show that it comprises a stack of metal plates or sheets 11 separated from one another by fins 12 forming spacers between said plates 11. Said fins 12 are brazed at the ends of the plates 11 so as to form there a brazed 3 matrix 2 (see also FIG. 1) to which one or more structures or containers 1 serving to collect and distribute the fluids in the exchanger 10 must be welded.

According to the invention, the “buttering” layers 5 to 7 are produced on the external surface of this brazed zone 3 of the matrix 2 of the exchanger 10, as explained above in relation to FIG. 1, before said fluid collecting and distributing container or structure is welded to this or these “buttering” layers 5 to 7 of pure copper that may contain alloying elements or inevitable impurities.

As explained above, to carry out the “buttering” pass or passes, the zone to be coated firstly undergoes localized preheating and then molten copper is deposited in this preheated zone, the said copper being supplied in the form of a meltable copper-based wire, which is melted by using an electric arc, in particular by means of an MIG torch. The MIG process is preferred as this welding process generates greater movement in the liquid pool of molten metal than the TIG process, thereby preventing any localized concentration of certain deleterious elements, such as phosphorus, particularly in the zones of the “buttering” bead 5 where it crosses the braze.

Moreover, to weld the workpiece (header container) to the copper-coated brazed zone, an arc welding torch is used, such as an MIG (Metal Inert Gas) torch, a TIG (Tungsten Inert Gas) torch or a plasma torch, or combinations of such torches, for example a plasma-MIG torch or MIG-TIG torches.

To do this, it is possible as a complement to supply a filler product of the copper/nickel or copper/aluminum type or, when it is desired to produce a bond between the copper-covered zone and a stainless steel workpiece, such as a fluid header, it is possible to provide the use of other filler products of the nickel or nickel-alloy type. In fact, in the case of the manufacture of a heat exchanger, it is possible to choose:
either to weld a stainless steel fluid header directly to the copper layers 5, 6, 7,
or to weld (via a welded joint 20) the stainless steel fluid header 21 to a copper intermediate workpiece 1 which is itself welded to the copper layers 5, 6, 7 as shown in FIG. 3.

The welding process of the invention is particularly well suited to the manufacture of brazed heat exchangers that can be used for separating air gases, in particular cryogenically within cryogenic distillation columns, since these exchangers will be more resistant to cracking problems than conventional exchangers.

1-20. (canceled).

21. A process for arc welding comprising:
i) depositing at least one layer of copper or of a copper alloy for which the phosphorus solubility limit is between about 0.1 and about 3.5% at the solidification temperature on at least part of a brazed matrix, said brazed matrix comprising at least one brazed zone, wherein said brazed zone comprises a braze comprising elements comprising copper and phosphorus; and
ii) welding at least one metal workpiece to said at least one layer of copper deposited in step i).

22. The process of claim 21, wherein said phosphorus solubility limit is in the range of from about 0.5 and about 3.5%.

23. The process of claim 22, wherein said phosphorus solubility limit is in the range of from about 1 and about 3.5%.

24. The process of claim 21, further comprising depositing several layers of said copper or copper alloy, wherein said layers are partly superposed.

25. The process of claim 21, wherein said braze further comprises at least one member selected from the group consisting of:
a) Sn,
b) Ag, and
c) Zn.

26. The process of claim 21, wherein said copper alloy further comprises at least one additional element selected from the group consisting of:
a) tin;
b) silicon;
c) manganese;
d) iron; and
e) nickel.

27. The process of claim 21, wherein said braze comprises from about 3 to 10% phosphorus, about 0 to 15% silver, and about 0 to 1% nickel.

28. The process of claim 21, wherein at least one said layer comprises less than about 1% tin, less than about 0.5% manganese, less than about 0.5% silicon, and less than about 0.05% iron.

29. The process of claim 21, further comprising:
i) preheating locally said zone to be coated;
ii) melting said copper or copper alloy with an electric arc; and
ii) depositing said copper or copper alloy in said preheated zone.

30. The process of claim 29, wherein said preheating is carried out by using one or more electric arcs.

31. The process of claim 30, wherein said preheating is carried out by using at least one arc generated by a TIG or plasma welding torch.

32. The process of claim 29, wherein said copper is supplied in the form of a copper wire and said electric arc for melting said copper wire is generated by at least one MIG welding torch.

33. The process of claim 21, wherein said workpiece is welded by at least one process selected from the group consisting of:
a) MIG;
b) TIG; and
c) plasma process.

34. The process of claim 33, wherein said workpiece is welded by a pulsed MIG process.

35. The process of claim 21, wherein said brazed matrix is supported by a stack of several plates separated by fins forming spacers between said plates, wherein said fins and said plates are brazed to one another to form said brazed matrix.

36. The process of claim 21, wherein said workpiece is a component of a fluid collecting or distributing container forming part of a heat exchanger.

37. The process of claim 36, wherein said workpiece comprises copper or stainless steel.

38. The process of claim 21, wherein said at least one layer deposited on said matrix has a width sufficient to allow a welded joint to be produced between said workpiece and said layer without incorporating into said welded joint additional elements originating from said brazed zone of said matrix.

39. A process for manufacturing a brazed copper heat exchanger, in which the welding process of claim 21 is utilized to weld at least one fluid collecting and distributing container of the exchanger to a stack of plates separated by fins forming spacers between said plates and supporting at least one brazed matrix.

40. The process of claim 39, wherein said fluid collecting and distributing container is made of copper.

41. A copper heat exchanger comprising at least one fluid collecting and distributing container welded to a brazed matrix supported by a stack of several plates separated by fins forming spacers between said plates, wherein said container is welded to at least one layer of copper or of a copper alloy for which the phosphorus solubility limit is between about 0.1 and about 3.5% at the solidification temperature, said at least one copper layer being deposited on said brazed matrix.

42. The exchanger of claim 41, wherein said fluid collecting and distributing container comprises copper or stainless steel.

43. A plant for separating fluids comprising at least one exchanger of claim 41.

44. The plant of claim 43, wherein said fluids to be separated are gas mixtures.

45. The plant of claim 43, wherein said plant is a cryogenic air separation unit.

46. A process for separating fluids, in which at least one heat exchanger of claim 41 is utilized.

47. The process of claim 46, wherein said fluids to be separated are gas mixtures.

48. The process of claim 47, wherein said fluid to be separated is air.

49. A process for coating a matrix comprising at least one brazed zone, the braze of which contains copper and phosphorus, the process comprising:
i) preheating the zone to be coated by exposing said zone to at least a first electric arc;
ii) supplying copper in the form of a meltable wire and progressively melting said copper wire by means of at least a second electric arc with deposition on the zone preheated by the first electric arc of step i) of copper melted by the second electric arc, said copper wire consisting of copper or a copper alloy for which the phosphorus solubility limit is between about 0.1 and about 3.5% at the solidification temperature; and
iii) solidifying the molten copper as at least one copper layer.

50. The process of claim 49, wherein said copper constituting the filler wire contained at most 2% by weight of at least one additional element selected from the group consisting of:
a) tin;
b) silicon;
c) manganese;
d) phosphorus;
e) iron; and
f) nickel.

51. The process of claim 49, wherein said copper constituting the filler wire is virtually free of phosphorus.
